(19) United States
(12) Patent Application Publication
(10) Pub. No.: US 2006/0119550 A1
(43) Pub. Date: Jun. 8, 2006

(54) Display module

(75) Inventor: Isao Akima, Ogaki-shi (JP)

Correspondence Address: MORRISON & FOERSTER LLP, 1650 TYSONS BOULEVARD, SUITE 300, MCLEAN, VA, 22102, US

(73) Assignee: SANYO ELECTRIC CO., LTD., Osaka (JP)

(21) Appl. No.: 11/281,894

(22) Filed: Nov. 18, 2005

(30) Foreign Application Priority Data
Nov. 18, 2004 (JP) 2004-333897

(51) Int. Cl. G09G 3/30

(52) U.S. Cl. 345/76

(57) ABSTRACT

A number of data transmission lines between a controller LSI and a display device and external devices is reduced to reduce a wiring space in a portable information device to realize further size reduction of the device. A controller LSI side transmission/reception circuit is included in the controller LSI, while an external device selection and transmission circuit and a display unit are included in a display device. And two-way transmission lines are provided between the controller LSI side transmission/reception circuit and the external device selection and transmission circuit. Various kinds of external devices MD0-MD3 for human interface are connected to the external device selection and transmission circuit.

### CROSS-REFERENCE OF THE INVENTION

This invention is based on Japanese Patent Application No. 2004-333897, the content of which is incorporated herein by reference in its entirety.

### BACKGROUND OF THE INVENTION

1. Field of the Invention

This invention relates to a display module equipped with a controller LSI that controls a display device and other external devices, and applicable to portable information devices such as a mobile phone and a PDA (Personal Digital Assistant), for example.

2. Description of the Related Art

The portable information devices such as the mobile phone and the PDA have come into widespread use in recent years. The portable information device uses a display module equipped with a controller LSI that controls a display device such as an LCD (Liquid Crystal Display) and various kinds of external devices for human interface such as a CCD (Charge Coupled Device) camera, a speaker, a light-emitting/receiving remote controller and a game controller.

In a conventional display module, as shown in FIG. 3, a video data transmission line 52 between a controller LSI 50 and a display device 51 and external device data transmission lines 53 between the controller LSI 50 and various kinds of external devices MD0-MD3 are disposed separately. The data transmission through the video data transmission line 52 and the external device data transmission lines 53 is unilateral data transmission, and the various kinds of data are transmitted as voltage signals using a CMOS type signal transmission circuit.

Further description on the technologies mentioned above is provided in Japanese Patent Application Publication No. H. 08-83055, for example.

However, there is a problem that the increased number of data transmission lines between the controller LSI 50 and the display device 51 and the external devices MD0-MD3 hampers reducing the size of the portable information device. In a new model of mobile phone, for example, the controller LSI 50 is housed in a main body on which a control panel is disposed, while the display device 51, the CCD camera and the speaker are housed in a cover. The cover can be folded and unfolded by means of a hinge provided at an edge of the main body so that the cover can be folded over the main body. The large number of data transmission lines to connect the controller LSI 50 with the display device 51 and the other devices have to go through the narrow hinge.

Since the various kinds of data are transmitted as the voltage signals through the data transmission lines, there arise problems such as EMI (Electromagnetic Interference) noise radiation that causes a very big interference in application to consumer video equipment, degradation in SN ratio of a voltage signal component and degradation in quality of an image due to a transmission propagation delay or a skew between the signals, when a frequency of the voltage signal is higher than several tens of MHz.

### SUMMARY OF THE INVENTION

The invention provides a display module that includes a display device, two or more of additional devices, a selection circuit selecting one of the additional devices, a controller LSI controlling the display device and the additional devices, a two-way transmission line, a first current drive circuit that provides the display device with a drive current corresponding to an image data through the two-way transmission line during a first period, a second current drive circuit that provides a selected additional device with a drive current corresponding to device control data through the two-way transmission line during a second period, and a third current drive circuit that provides the controller LSI with data from another selected additional device through the two-way transmission line.

### BRIEF DESCRIPTION OF THE DRAWINGS

FIG. 1 is a block diagram showing a display module according to an embodiment of this invention.

FIG. 2 is a circuit diagram showing the display module according to the embodiment of this invention.

FIG. 3 is a block diagram showing a display module according to a prior art.

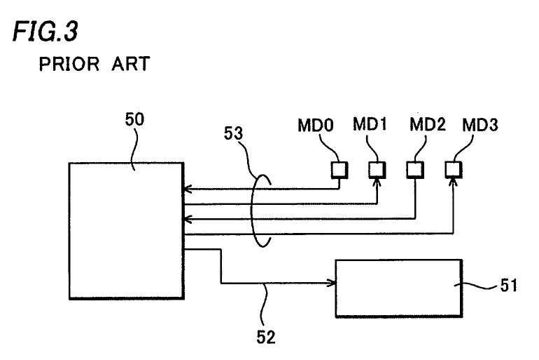

### DETAILED DESCRIPTION OF THE INVENTION

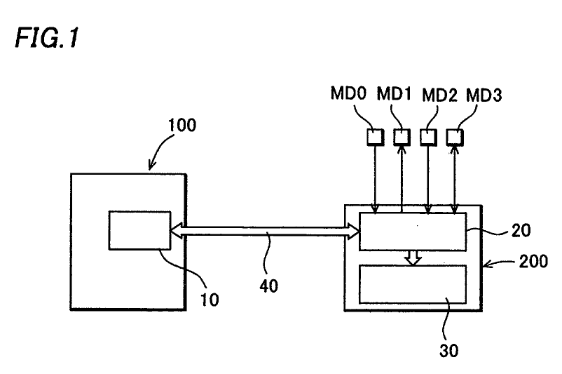

Next, a display module according to an embodiment of this invention will be described hereafter, referring to the drawings. A block diagram of a whole structure of the display module is shown in FIG. 1. A controller LSI side transmission/reception circuit 10 is provided in a controller LSI 100, while an external device selection and transmission circuit 20 and display unit 30 are provided in a display device 200. And two-way transmission lines 40 are provided between the controller LSI side transmission/reception circuit 10 and the external device selection and transmission circuit 20. Various kinds of external devices MD0-MD3 for human interface are connected to the external device selection and transmission circuit 20. A CCD camera, a speaker, a light-emission/transmission remote controller using a light-emission/transmission device and a game controller may be included as the external devices MD0-MD3. A display device may be also included as one of the external devices.

In addition to the controller LSI side transmission/reception circuit 10, the controller LSI 100 is equipped with a processor that performs prescribed signal-processing on externally-supplied image data of three primary colors RGB, a frame memory to store the image data which is signal-processed by the processor and a timing controller to generate various kinds of timing signals to drive the display device 200.

To describe an outline of operation of the display module, the controller LSI side transmission/reception circuit 10 in the controller LSI 100 provides the display device 200 with a drive current corresponding to the image data and the various kinds of timing signals through the two-way transmission lines 40 during an image display period. With this, the image is displayed on the display unit 30 in the display device 200.

The controller LSI side transmission/reception circuit 10 also provides an external device (MD1, for example) selected by the external device selection and transmission circuit 20 with a drive current corresponding to external device control data through the two-way transmission lines 40 during a blanking interval. With this, the control of the external device is made possible.

And the external device selection and transmission circuit 20 provides the controller LSI 100 with data from another external device (MD0, for example) that is selected by its selection circuit through the two-way transmission lines 40 during the blanking interval. Thus, the number of the transmission lines connected to the controller LSI 100 can be substantially reduced by the time-shared two-way transmission method according to the display module of this embodiment.

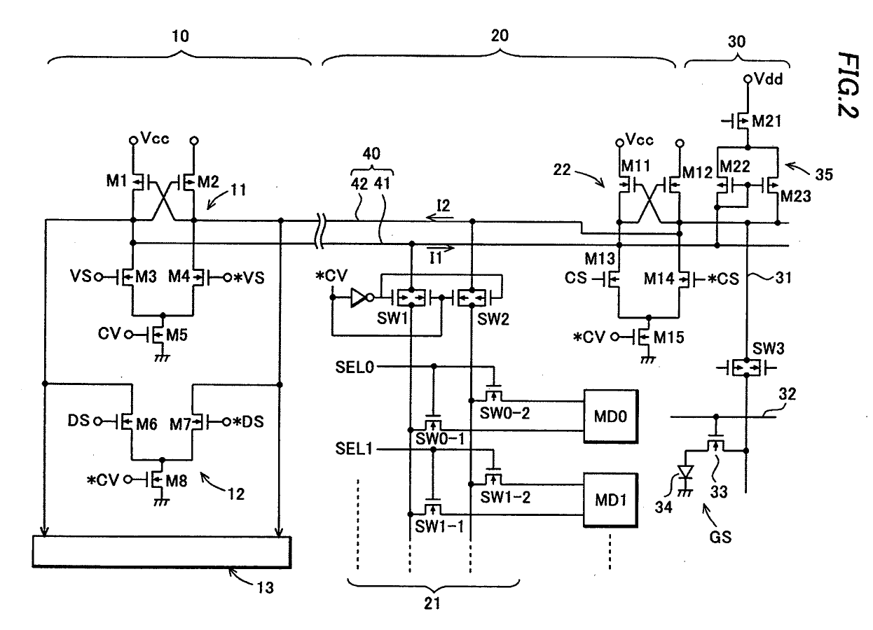

Next, a detailed structure of the display module will be explained referring to FIG. 2. The controller LSI side transmission/reception circuit 10 embedded in the controller LSI 100 is equipped with a first current drive circuit 11, a second current drive circuit 12 and a reception circuit 13 that are connected with the two-way transmission lines 40.

The first current drive circuit 11 includes a pair of P-channel type MOS transistors M1 and M2, gates and drains of which are cross-connected with each other, and a pair of N-channel type MOS transistors M3 and M4 that constitute a differential transistor pair. Pulse-width modulated image data VS is applied to a gate of the N-channel type MOS transistor M3, while inverted image data *VS is applied to a gate of the N-channel type MOS transistor M4. An image display period signal CV is applied to a gate of an N-channel type MOS transistor M5 that provides the pair of N-channel type MOS transistors M3 and M4 with a constant current. The image display period signal CV is at a high level during the image display period. Thus M5 is turned on during the image display period to put the first current drive circuit 11 into operation.

A first transmission line 41 of the two-way transmission lines 40 is connected to a drain of the N-channel type MOS transistor M3, while a second transmission line 42 of the two-way transmission lines 40 is connected to a drain of the N-channel type MOS transistor M4. The first and the second transmission lines 41 and 42 are disposed adjacent to each other, and each of them is provided with each of a first drive current I1 and a second drive current I2, respectively. The first and the second drive currents I1 and I2 are equal in amount and opposite in direction of current flow to each other.

The second current drive circuit 12 includes a pair of N-channel type MOS transistors M6 and M7 that constitute a differential transistor pair. Pulse-width modulated external device control data DS is applied to a gate of the N-channel type MOS transistor M6, while inverted external device control data *DS is applied to a gate of the N-channel type MOS transistor M7. A blanking interval signal *CV is applied to a gate of an N-channel type MOS transistor M8 that provides the pair of N-channel type MOS transistors M6 and M7 with a constant current. The cross-connected pair of P-channel type MOS transistors M1 and M2 in the first current drive circuit 11 is also used in the second current drive circuit 12.

The blanking interval signal *CV is an inverted signal of the image display period signal CV, and is at the high level during the blanking interval. Thus M8 is turned on during the blanking interval to put the second current drive circuit 12 into operation. The second transmission line 42 is connected to a drain of the N-channel type MOS transistor M6, while the first transmission line 41 is connected to a drain of the N-channel type MOS transistor M7.

The external device selection and transmission circuit 20 includes a selection circuit 21 and a third current drive circuit 22. The selection circuit 21 selects one of the external devices MD0, MD1, - - - corresponding to external device selection signals SEL0, SEL1, - - - and connects the selected external device with the first and the second transmission lines 41 and 42 during the blanking interval. That is, the selection circuit 21 includes external device connection switches SW1 and SW2 that are turned on according to the blanking interval signal *CV, external device selection switches SW0-1 and SW0-2 that are turned on according to the external device selection signal SEL0 and external device selection switches SW1-1 and SW1-2 that are turned on according to the external device selection signal SEL1.

The third current drive circuit 22 is a balanced current amplifier and includes a pair of P-channel type MOS transistors M11 and M12 and a pair of N-channel type MOS transistors M13 and M14 that constitute a differential transistor pair. A power supply voltage Vcc is applied to drains of M11 and M12 while gates and drains of M11 and M12 are cross-connected with each other. A selection circuit side transmission signal CS is applied to a gate of the N-channel type MOS transistor M13, while an inverted selection circuit side transmission signal *CS is applied to a gate of the N-channel type MOS transistor M14. The blanking interval signal *CV is applied to a gate of an N-channel type MOS transistor M15 that provides the pair of N-channel type MOS transistors M13 and M14 with a constant current. The blanking interval signal *CV is at the high level during the blanking interval. Thus M15 is turned on during the blanking interval to put the third current drive circuit 22 into operation. With the third current drive circuit 22, when a plurality of external devices that can perform two-way transmission is connected with the first and the second transmission lines 41 and 42, the two-way transmission is made possible by controlling the external devices in time-shared drive and controlling the direction of the signal transmission.

The display unit 30 in the display device 200 includes a data line 31 connected with the second transmission line 42, a display selection switch SW3 disposed at a midpoint of the data line 31 and a pixel GS. The pixel GS includes a pixel selection TFT (Thin Film Transistor) 33 that is controlled by a gate signal line 32 and an organic EL (Electro-luminescence) device 34 as a light-emitting display device. An LCD (Liquid Crystal Display) may be used instead of the light-emitting display device. A current amplifier circuit 35 is composed of three P-channel type MOS transistors M21, M22 and M23, and amplifies a drive current transferred through the second transmission line 42.

Next, an example operation of the display module shown in FIG. 2 will be explained. During the image display period, the image display period signal CV is at the high level, and the first current drive circuit 11 in the controller LSI side transmission/reception circuit 10 is activated. Then the first current drive circuit 11 outputs a drive current corresponding to the image data signal VS and *VS to the two-way transmission lines 40 to provide the display device 200 with it. The drive current is amplified by the current amplifier circuit 35 in the display unit 30, and is supplied to the selected pixel GS through the data line 31 and the switch SW3, and turns the organic EL device 34 on and off correspondingly. With this, the image is displayed on the display unit 30 in the display device 200.

During the blanking interval, the blanking interval signal *CV is at the high level, and the second current drive circuit 12 in the controller LSI side transmission/reception circuit 10 is activated. In the selection circuit 21, on the other hand, the external device connection switches SW1 and SW2 are turned on. The external device selection switches SW1-1 and SW1-2 are turned on as the external device selection signal SEL1 goes to the high level. With this, the external device MD1 is selected and connected to the two-way transmission lines 40. When the external device MD1 is a speaker, for example, the second current drive circuit 12 outputs a drive current corresponding to an audio signal to the first and the second transmission lines 41 and 42 of the two-way transmission lines 40 as the external device control data DS and *DS. The drive current is supplied to the external device MD1 through the external device connection switches SW1 and SW2 and the external device selection switches SW1-1 and SW1-2.

Note that the external device MD1 may be the display unit 30 as shown in FIG. 2. In this case, the image data signal is provided as the external device control data DS and *DS.

Suppose that the external device selection signal SEL0 becomes the high level to turn on the external device selection switches SW0-1 and SW0-2 and select the external device MD0 during the blanking interval. The external device MD0 is assumed to be a CCD camera. In this case, data from the external device MD0 is outputted as a current signal to the first and the second transmission lines 41 and 42 of the two-way transmission lines 40 through the external device connection switches SW1 and SW2 and the external device selection switches SW0-1 and SW0-2.

On the other hand, the blanking interval signal *CV becomes the high level and the third current drive circuit 22 is activated to let the drive current flow through the first and the second transmission lines 41 and 42 according to the data (selection circuit side transmission signal CS and *CS) from the external device MD0. In other words, the third current drive circuit 22 amplifies the current signal from the external device MD0. It is preferable for appropriate amplification that the data from the external device MD0 is delayed so that the data from the external device MD0 is supplied to the third current drive circuit 22 after the data from the external device MD0 is outputted to the first and the second transmission lines 41 and 42.

According to the display module of this invention, the number of the data transmission lines between the controller LSI and the display device and the external devices can be reduced to realize a further reduction in size of a portable information device by reducing the wiring space.

Also, control processing of the controller LSI can be simplified by the reduction in the number of the data transmission lines. Furthermore, since the transmission of the image data and the like is performed by providing the transmission lines with the two-way current corresponding to the image data and the like, EMI noise radiation and degradation in SN ratio of the signal can be avoided and a signal transmission of the high frequency image data is made possible by suppressing a propagation delay and a skew between the signals associated with a transmission capacitance.

What is claimed is:

1. A display module comprising:
a display device;
two or more of additional devices;
a selection circuit selecting one of the additional devices;
a controller LSI controlling the display device and the additional devices;
a two-way transmission line;
a first current drive circuit that provides the display device with a drive current corresponding to an image data through the two-way transmission line during a first period;
a second current drive circuit that provides a selected additional device with a drive current corresponding to device control data through the two-way transmission line during a second period; and
a third current drive circuit that provides the controller LSI with data from another selected additional device through the two-way transmission line.

2. The display module of claim 1, wherein the two-way transmission line comprises a first transmission line transferring a current in a first direction and a second transmission line transferring a current in a second direction opposite from the first direction.

3. The display module of claim 2, wherein the first and second transmission lines transfer a same amount of current in a same time sequence in respective directions.

4. The display module of claim 1, wherein the first current drive circuit and the second current drive circuit are part of the controller LSI and the selection circuit and the third current drive circuit are part of the display device.

5. The display module of claim 1, wherein the first period is an image display period and the second period is a blanking interval of the display device.

6. The display module of claim 1, wherein the display device comprises a liquid crystal display device or an electroluminescent display device.
